(19) United States
(12) Patent Application Publication
(10) Pub. No.: US 2025/0188952 A1
(43) Pub. Date: Jun. 12, 2025

(54) FAN HOUSING FOR A COMPRESSOR INSTALLATION

(71) Applicant: Atlas Copco Airpower, Naamloze Vennootschap, Wilrijk (BE)

(72) Inventors: DANIEL GUARIGLIA, WILRIJK (BE); FLIP MATHYS, WILRIJK (BE)

(21) Appl. No.: 18/846,184

(22) PCT Filed: Mar. 7, 2023
(86) PCT No.: PCT/IB2023/052151

§ 371 Date: Sep. 11, 2024

(30) Foreign Application Priority Data
Mar. 16, 2022 (BE) BE2022/5180
Jun. 10, 2022 (BE) BE2022/5453

(51) Int. Cl. F04D 29/66; F04D 17/08; F04D 29/42

(52) U.S. Cl. CPC F04D 29/664; F04D 17/08; F04D 29/4226

(57) ABSTRACT

An air-cooled compressor installation is provided with a housing including at least one air-cooled cooler, provided with a fan. The fan is provided with a fan housing with a fan inlet and a cooling air outlet, wherein the fan inlet connects to the cooler and the cooling air outlet is located at a roof of said housing of the compressor installation and wherein the cooling air outlet does not intersect the geometric extension of the fan along the vertical direction, wherein the axis of rotation of the radial fan extends at an angle between 0° and 45° relative to the vertical direction.

### BACKGROUND OF THE INVENTION

### 1. Field of the Invention

The present invention relates to an air-cooled compressor installation.

More specifically, the invention is intended for an air-cooled compressor installation provided with a housing comprising at least one air-cooled cooler with a radial fan.

### 2. Description of Related Art

Traditionally, such a fan is provided with a fan housing with a cooling air inlet and an opposing cooling air outlet.

In order to optimize the intake of cooling air, the cooling air inlet is in line with the axis of rotation of the fan.

This housing closely matches the physical dimensions of the fan in order to obtain a unit that is as compact as possible.

This results in the cooling air having to bend to exit the housing through the cooling air outlet.

The disadvantage of this is that a pressure drop is created, that the exhaust flow is not uniform and that noise nuisance is generated.

### SUMMARY OF THE INVENTION

The present invention aims to provide a solution to said and other disadvantages.

To this end, the invention relates, according to a first aspect, to a fan housing configured to house a radial fan for drawing in cooling air from an air-cooled compressor installation, the fan housing comprising a fan inlet connectable to a cooler of the compressor installation, and a cooling air outlet, the fan inlet and the cooling air outlet respectively being located in a first plane respectively second plane of the housing, the first plane being parallel and opposite to the second plane, characterized in that the axis of rotation of the radial fan when housed at the fan inlet extends at an angle between 0° and 45° relative to a direction perpendicular to the first plane, and further the edge of the cooling air outlet does not intersect with the geometric extension of the outer shell along the axis of rotation of the radial fan to the second plane.

A radial fan means a fan that draws in air parallel to the shaft and leaves it perpendicular to said shaft. Stated differently, a radial fan sucks the air axially into the center of its impeller, then pushes it through the rotating blades and throws it radially outward. A radial fan is also understood to mean a centrifugal fan as known in the prior art. The radial or centrifugal fan may further comprise a casing or housing as known in the art and is therefore different from the fan housing according to the invention.

With the direction perpendicular to the first plane is meant here the direction perpendicular to the ground surface. The ground surface is the surface on which the compressor installation rests or is mounted.

With the geometric extension of the outer shell of the fan along the axial direction of the axis of rotation is meant here the virtual extension or geometric projection of the outer shell of the fan, in line with the axis of rotation towards the roof of the fan housing. The intersection plane of this virtual extension with the roof does not overlap with the cooling air outlet or, in other words, the cooling air outlet does not fall within this intersection, not even partially. The roof then also means the side where the cooling air outlet is located. In a normal arrangement, this side is therefore located at the top of the housing when the compressor installation of which the fan housing forms part is located on the ground surface.

The invention has the advantage that the pressure drop between the cooling air outlet and the fan is reduced.

As a result, the fan consumes less energy and optionally, it is even possible to choose a fan with a smaller capacity.

Another advantage is that the exhaust flow at the cooling air outlet is uniform or almost uniform because the entire surface of the cooling air outlet is used.

Yet another advantage is that the fan is better protected against rain, snow, dust and the like since the fan is not located directly under the cooling air outlet.

Preferably, a wall of the fan housing that connects to the cooling air outlet and is not located at the roof of said housing of the compressor installation extends at an obtuse angle to the vertical direction, being the direction perpendicular to the ground surface, and intersecting with the center point of the fan inlet.

This has the advantage that airflow is guided in the direction of the cooling air outlet. This will also reduce the pressure drop.

In a preferred embodiment, the fan housing is provided on its inside with sound-absorbing material.

This has the advantage that noise nuisance is kept to a minimum.

The sound-absorbing material is preferably manufactured from polyurethane foam, melamine foam, viscoelastic foam, rock wool, glass wool or an acoustic cloth.

Such materials have good sound-absorbing properties and are suitable for lining the inside of the fan housing.

Preferably, a number of baffles or baffles plates is arranged in the flow path of the air stream between the fan and cooling air outlet.

These partitions or baffle plates have the advantage that the noise nuisance is reduced even further.

These baffles or baffle plates can be reflection dampers or absorption dampers, in which case also the baffles or baffle plates are covered with sound-absorbing material or are manufactured from sound-absorbing material.

The fan housing is preferably provided with a removable wall.

This removable wall can serve as a service hatch to inspect, clean or replace the fan or sound-absorbing material.

In a preferred embodiment, the geometric extension of the axis of rotation of the fan when housed always passes through the fan inlet, and even more preferred through the center point of the fan inlet.

This ensures that the fan inlet and a suction side of the fan are always correctly aligned.

According to a second aspect of the invention, an air-cooled compressor installation is disclosed comprising the fan housing according to the first aspect.

According to an embodiment the compressor installation may further comprise a radial fan housed in the fan housing.

With the aim of better demonstrating the features of the invention, a preferred embodiment of an air-cooled compressor installation according to the invention is described below, by way of example, without any limiting character, with reference to the appended drawings, in which:

### BRIEF DESCRIPTION OF THE DRAWINGS

FIG. 1 schematically represents an air-cooled compressor installation with an air-cooled cooler and a traditional fan housing;

FIG. 2 shows the air-cooled cooler of FIG. 1 with a fan housing according to the invention;

FIG. 3 shows the air-cooled cooler of FIG. 2 with partitions in the fan housing;

FIG. 4 shows the air-cooled cooler of FIG. 2 with baffle plates in the fan housing;

FIG. 5 shows a top view of the air-cooled cooler and the fan housing, which are indicated by the arrow F5 in FIG. 2.

### DETAILED DESCRIPTION OF EXEMPLARY EMBODIMENTS

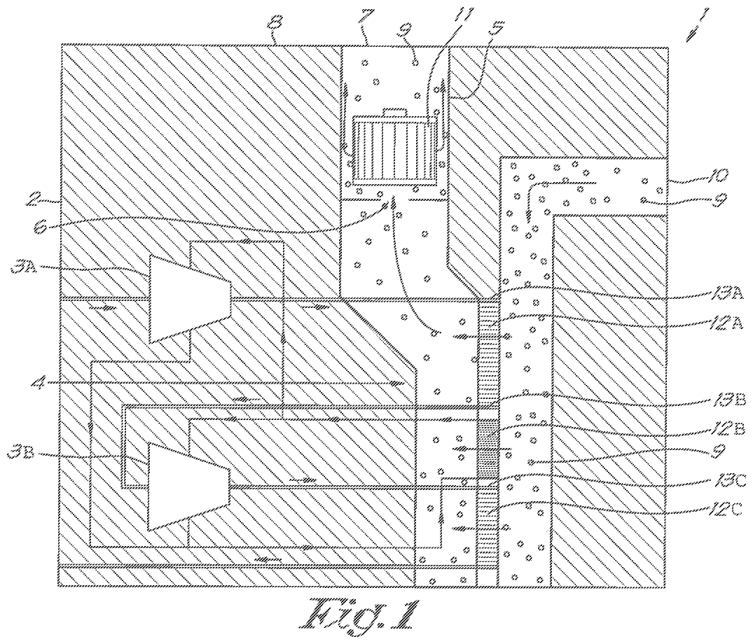

FIG. 1 shows a traditional air-cooled compressor installation 1 with a compressor housing 2 wherein two compressor elements 3A and 3B and an air-cooled cooler 4 are accommodated.

The compressor elements 3A and 3B form a low-pressure stage 3A and a high-pressure stage 3B, respectively. However, the number of compressor elements 3 is not important for the invention and the invention can also be applied to compressor installations 1 with only one compressor element or with more than two compressor elements.

The compressor elements 3A and 3B can be of any type, for example reciprocating compressors, screw compressors, turbo compressors, etc. and can be both oil-free and oil-injected.

The compressor elements 3A and 3B are cooled using the air-cooled cooler 4. This air-cooled cooler 4 is connected to a fan housing 5 with a fan inlet 6 and cooling air outlet 7.

The fan inlet 6 is connected to the cooler 4 and the cooling air outlet 7 is located at a roof 8 of the compressor installation 1.

A cooling air flow 9 is sucked into the cooler 4 via a cooling air inlet 10 of the compressor installation 1 with the aid of a fan 11. In this case, the fan 11 is a radial fan 11.

In this case, the cooler 4 consists of three partial coolers 12A, 12B and 12C wherein a medium to be cooled 13A, 13B and 13C flows.

In the example shown, the three partial coolers 12A, 12B and 12C are all cooled by said radial fan 11. In this case, the first partial cooler 12A is an intercooler 12A, the second partial cooler 12B is an oil cooler 12B and the third partial cooler 12C is an aftercooler 12C.

In this example, the cooling medium 13A and 13C in the first partial cooler 12A and third partial cooler 12C, intercooler 12A and aftercooler 12C, respectively, is compressed gas originating from the compressor elements 3A and 3B, while the cooling medium 13B in the second partial cooler 12B is oil.

The cooling air stream 9 flows through the partial coolers 12A, 12B and 12C, after which it enters the fan inlet 6 of the fan housing 5.

Subsequently, the cooling air flow 9 undergoes a speed increase and a change of direction in the radial fan 11. The air flow 9 leaves the radial fan 11 along the outer circumference, after which the air flow 9 must again undergo a change of direction in order to leave the roof 8 of the compressor installation 1 via the cooling air outlet 7.

As a result, a large part of the cooling air outlet 7 is blocked by the radial fan 11. This has an adverse effect on the power of the fan 11. Moreover, the cooling air outlet 7 must be made larger in order to realize an efficient discharge of the cooling air flow 9.

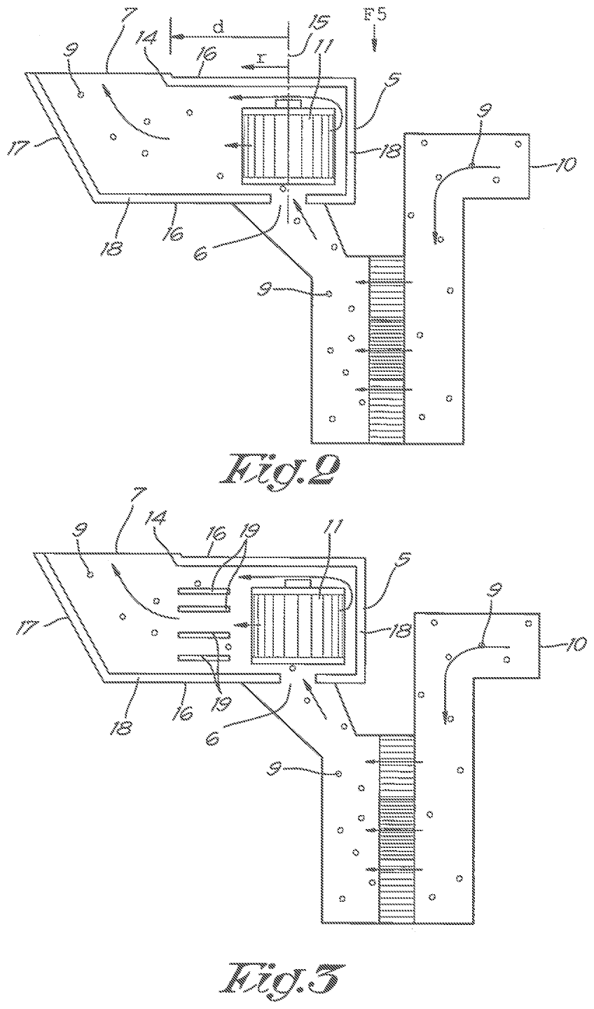

FIG. 2 shows the same air-cooled cooler 4 as FIG. 1, but in this case with a fan housing 5 according to the invention. The fan housing 5 is dimensioned such that the geometric extension of the fan 11 in the vertical direction does not intersect the cooling air outlet 7.

This means that the top of the radial fan 11 is, as it were, covered or overlayed by the fan housing 5.

As a result, an edge 14 of the cooling air outlet 7, closest to the axis of rotation 15 of the fan 11, is located at a greater distance d from the axis of rotation 15 of the fan 11 than the radius r of the fan 11.

The angle between the axis of rotation 15 of the fan 11 and the vertical direction is in this case 0°, although it is not excluded that this angle can be up to 45°.

Note here that, in the embodiment shown, the rotation shaft 15 passes through the fan inlet 6.

In this example, the fan inlet 6 and the cooling air outlet 7 are arranged in opposite walls 16 of the fan housing 5.

A wall 17 of the fan housing 5 that connects to the cooling air outlet 7 and is not located at the roof 8 of said housing 2 of the compressor installation 1, in this case extends at an angle to the vertical direction, to guide the airflow to the cooling air outlet 7.

This aforementioned angle is less than 90°.

This wall 17 will gradually deflect the cooling air flow 9 blown out by the fan 11 and guide it to the cooling air outlet 7.

In this example, the fan housing 5 is provided on its inside with sound-absorbing material 18 in the form of polyurethane foam. However, it cannot be ruled out that this sound-absorbing material 18 is manufactured from melamine foam, viscoelastic foam, rock wool, glass wool or an acoustic cloth.

The sound-absorbing material 18 is clearly shown in FIG. 2.

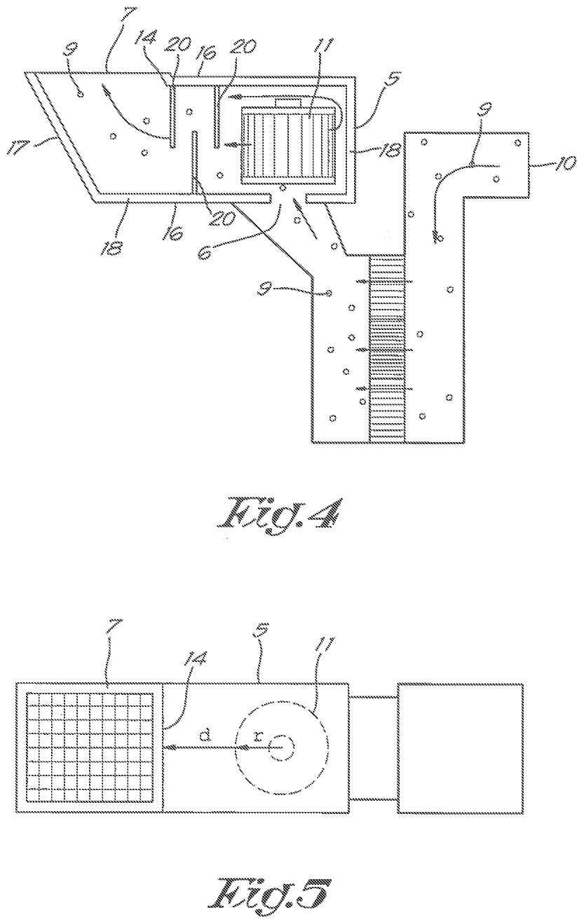

In FIGS. 3 and 4, baffles 19 and baffles plates 20, respectively, are mounted between the fan 11 and the cooling air outlet 7, which are intended to further limit the noise nuisance.

The cooling air stream 9, blown out by the fan 11, will have to bend around these baffles 19 or baffle plates 20, which will produce a sound-damping effect.

FIG. 5 shows a top view of the fan housing 5 and the cooler 4, in which it is clearly visible that the geometric extension of the fan 11 perpendicular to the plane of the Figure does not intersect the cooling air outlet 7 anywhere and is therefore, as it were, located at a distance d from the cooling air outlet 7.

It is clear from this figure that the entire surface of the cooling air outlet 7 is now used for discharging the air flow 9 and that consequently, the air flow 9 through the cooling air outlet 7 is uniform or quasi-uniform.

It can also be seen from this figure that the fan 11 is well-protected from the weather elements and dust since it is not located directly below the cooling air outlet 7.

It is clear that the cooler 4 and the fan housing 5 can be configured in many different ways.

Although the example described above, uses two compressor elements 3 and three partial coolers 12A, 12B and 12C, the invention is not limited thereto. The invention is applicable to compressor installations 1 with one or more than two compressor elements 3, and one partial cooler 12 or more than three partial coolers 12 are also possible.

It is also possible that the various partial coolers 12 are cooled by separate fans 11.

The present invention is by no means limited to the embodiments described by way of example and shown in the figures, but an air-cooled compressor installation according to the invention can be realized in all kinds of shapes and dimensions without departing from the scope of the invention.

1.-10. (canceled)

11. A fan housing comprising a radial fan, configured to house a radial fan for drawing in cooling air from an air-cooled compressor installation, the fan housing comprising a fan inlet connectable to a cooler of the compressor installation, and a cooling air outlet, the fan inlet and the cooling air outlet respectively being located in a first plane respectively second plane of the housing, the first plane being parallel and opposite to the second plane, wherein the axis of rotation of the radial fan when housed at the fan inlet extends at an angle between 0° and 45° relative to a direction perpendicular to the first plane, and further the edge of the cooling air outlet does not intersect with the geometric extension of an outer shell along the axis of rotation of the radial fan to the second plane, the geometric extension of the axis of rotation of the radial fan passes through the fan inlet, wherein the fan housing is provided on its inside with sound-absorbing material.

12. A fan housing according to claim 1, wherein the sound-absorbing material is manufactured from polyurethane foam, melamine foam, viscoelastic foam, rock wool, glass wool or an acoustic cloth.

13. A fan housing according to claim 1, wherein a number of baffles and/or baffle plates is arranged in the flow path of the air stream between the fan and cooling air outlet.

14. A fan housing according to claim 1, wherein the fan housing is provided with a removable wall.

15. A fan housing according to claim 1, wherein the geometric extension of the axis of rotation of the radial fan when housed passes through the fan inlet.

16. An air-cooled compressor installation comprising the fan housing according to claim 11.

17. A kit of parts comprising a fan housing according to claim 11, including a radial fan suitable to be housed by the fan housing, a cooler suitable for being connected to the fan housing, and a compressor.
